(19) United States
(12) Patent Application Publication
(10) Pub. No.: US 2025/0065489 A1
(43) Pub. Date: Feb. 27, 2025

(54) BACK SUPPORT EXOSKELETON

(71) Applicant: Element Exo, Inc., Allison Park, PA (US)

(72) Inventors: Taylor PESEK, Allison Park, PA (US); Alan ASBECK, Blacksburg, VA (US); Tim POTE, Alexandria, VA (US)

(73) Assignee: Element Exo, Inc., Allison Park, PA (US)

(21) Appl. No.: 18/813,837

(22) Filed: Aug. 23, 2024

Related U.S. Application Data
(60) Provisional application No. 63/534,200, filed on Aug. 23, 2023.

(51) Int. Cl. B25J 9/00

(52) U.S. Cl. CPC B25J 9/0006

(57) ABSTRACT

In one approach to assisting in movement a wearable device is provided. In one embodiment, the wearable device includes an upper body anchor configured for positioning on a torso of a user. The wearable device further includes a first leg anchor configured for positioning on a first leg of the user and a second leg anchor configured for positioning on a second leg of the user. In this embodiment, the wearable device further includes a connecting element between the first leg anchor and the second leg anchor, and an energy storage device connected to the upper body anchor that includes one or more pulleys or channels through which the connecting element passes, where the first leg anchor or the second leg anchor includes a stiffening layer.

### CROSS-REFERENCE TO RELATED APPLICATION

This patent application claims priority to U.S. Provisional Patent Application No. 63/534,200, filed on Aug. 23, 2023, and entitled “BACK SUPPORT EXOSKELETON.” The disclosure of the prior application is considered part of and is incorporated by reference, in its entirety, into this patent application.

### FIELD OF THE INVENTION

The invention described here relates to a back support exoskeleton, worn to support a wearer while they lift heavy objects and relieve loads from their lower back.

### BACKGROUND

Back exoskeletons can be extremely useful in relieving loads from a wearer's back while they are bending and lifting, because they pull up on the wearer's torso, reducing the amount of muscle force the wearer must use to hold a bent posture or rise up from one.

### SUMMARY

Embodiments of the present invention disclose wearable devices for assisting in movement. In some embodiments, the wearable device can be a back support exoskeleton or exosuit.

In one embodiment, a wearable device includes an upper body anchor configured for positioning on a torso of a user, a first leg anchor configured for positioning on a first leg of the user and a second leg anchor configured for positioning on a second leg of the user. The wearable device further includes a connecting element between the first leg anchor and the second leg anchor, and an energy storage device connected to the upper body anchor that includes one or more pulleys or channels through which the connecting element passes, where the first leg anchor or the second leg anchor includes a stiffening layer.

In an embodiment, a back support exoskeleton or exosuit includes a left leg pad and a right leg pad respectively configured to secure around respective legs of a wearer and a differential strap configured to connect the left leg pad and right leg pad, where either the left leg pad or the right leg pad includes a stiffening layer.

In an embodiment, a wearable device includes an upper body anchor configured for positioning on a torso of a user, a first leg anchor configured for positioning on a first leg of the user, and a second leg anchor configured for positioning on a second leg of the user. The wearable device further includes a connecting element between the first leg anchor and the second leg anchor, and an energy storage device connected to the upper body anchor, that includes one or more pulleys or channels through which the connecting element passes, where the first leg anchor or the second leg anchor includes a loop at a back of either the first leg anchor or the second leg anchor retaining the connecting element, and the connecting element terminates on the first leg anchor or the second leg anchor at a location further forward on the anchor than the loop at the back of either the first leg anchor or the second leg anchor.

In an embodiment, a back support exoskeleton or exosuit includes a left leg pad and a right leg pad, where the leg pad and the right leg pad are configured to secure around a wearer's respective legs. The back support exoskeleton or exosuit further includes a differential strap connecting the left leg pad and right leg pad, where either the left leg pad or the right leg pad contains a loop disposed at a back surface of either the first leg pad or the left leg pad configured to retain the differential strap, and the differential strap can be adjusted in length through a buckle that is disposed further forward on the leg pad than the loop at the back surface.

In another embodiment, a wearable device includes an upper body anchor configured for positioning on a torso of a user, a first leg anchor configured for positioning on a first leg of the user, a second leg anchor configured for positioning on a second leg of the user, and a connecting element between the first leg anchor and the second leg anchor. The wearable device further includes one or more pulleys or channels connected to the upper body anchor, through which the connecting element passes, where the first leg anchor or the second leg anchor includes a loop at a back surface of either the first leg anchor or the second leg anchor configured to retain the connecting element, and the connecting element terminates on either the first leg anchor or the second leg anchor at a location further forward on the respective leg anchor than the loop at the back surface.

In another embodiment, a wearable device includes an upper body anchor configured for positioning on a torso of a user, a first leg anchor configured for positioning on a first leg of the user, a second leg anchor configured for positioning on a second leg of the user and a connecting element between the first leg anchor and the second leg anchor. The wearable device further includes one or more pulleys or channels connected to the upper body anchor, through which the connecting element passes; a load distribution element connected to either the first leg anchor or the second leg anchor or both the first and second leg anchor, where each load distribution element is connected to a respective leg anchor at its ends, and the connecting element that passes through the pulleys or channels is connected to the center of at least one load distribution element.

In another embodiment, a wearable device includes an upper body anchor configured for positioning on a torso of a user, a first leg anchor configured for positioning on a first leg of the user, a second leg anchor configured for positioning on a second leg of the user, a connecting element between the first leg anchor and the second leg anchor, one or more pulleys or channels connected to the upper body anchor, through which the connecting element passes; and one or more load distribution elements connected to the first leg anchor, the second leg anchor, or both of the first and second leg anchors, where each load distribution element of the one or more load distribution elements is connected to either the first or the second leg anchor at its ends, at least one load distribution element includes a loop at its center; and the connecting element that passes through the one or more pulleys or channels passes through the loop on a respective load distribution element before terminating on a respective leg anchor.

In another embodiment, a back support exoskeleton or exosuit includes a first and a second leg pad configured to secure around respective legs of a wearer and a V-shaped strap operably connected to a back portion of each leg pad. The back support exoskeleton or exosuit further includes a differential strap operably connected to the center of at least one V-shaped strap that connects the first leg pad and second leg pad.

In another embodiment, a back support exoskeleton or exosuit includes a first and a second leg pad configured to secure around respective legs of a wearer and a V-shaped strap at the back of each leg pad. The back support exoskeleton or exosuit further includes a differential strap operably connected to a loop at a center of at least one V-shaped strap that connects the left leg pad and right leg pad.

In another embodiment, a wearable device includes an upper body anchor configured for positioning on a torso of a user, a first leg anchor configured for positioning on a first leg of the user, a second leg anchor configured for positioning on a second leg of the user, where one or both leg anchors comprises a first end and a second end of the anchor, and wherein half a click buckle is operably connected to the first end and the other half of the click buckle in series with a strap buckle on the second end of the anchor.

In another embodiment, a back support exoskeleton or exosuit includes leg pads, where the leg pads are configured to secure around thighs of a wearer, and where tightness of respective leg pads are configured to be adjusted by a click buckle in series with a strap buckle.

In another embodiment, a wearable device includes an upper body anchor configured for positioning on a torso of a user, a first leg anchor configured for positioning on a first leg of the user and a second leg anchor configured for positioning on a second leg of the user. The wearable device further includes a connecting element between the first leg anchor and the second leg anchor, wherein either the first leg anchor or the second leg anchor includes a cam buckle and strap buckle, wherein the connecting element is configured to secure the first and the second leg anchor with the cam buckle and strap buckle.

In another embodiment, a back support exoskeleton or exosuit includes leg pads configured to secure around thighs of a wearer and a differential strap including a cam buckle in series with a strap buckle configured to adjust tightness of the differential strap that is operable to connect the left leg pad and right leg pad.

In another embodiment, a wearable device includes an upper body anchor configured for positioning on the torso of a user, a first leg anchor configured for positioning on the first leg of the user and a second leg anchor configured for positioning on the second leg of the user. The wearable device further includes a spring structure configured to connect to the upper body anchor, the first leg anchor, and the second leg anchor, wherein the spring structure comprises an upper spring and a lower spring, wherein each of the upper spring and lower spring are comprised of one or more beams, and wherein the upper spring and lower spring can be positioned relative to each other to increase or decrease overall length of the at least one spring structure.

In another embodiment, a back support exoskeleton includes an energy return mechanism, where the energy return mechanism includes at least one spring structure having an upper spring and a lower spring, where each of the upper spring and lower spring comprises one or more beams, and where the upper spring and lower spring can be positioned relative to each other to increase or decrease overall length of the at least one spring structure.

In another embodiment, a wearable device includes an upper body anchor configured for positioning on a torso of a user, a first leg anchor configured for positioning on a first leg of the user and a second leg anchor configured for positioning on a second leg of the user. The wearable device further includes a spring structure configured to connect to the upper body anchor, the first leg anchor, and the second leg anchor, where the spring structure comprises at least one stack of leaf springs, where the at least one stack of leaf springs include one or more beams, and where the one or more beams can be positioned relative to each other to increase or decrease overall length of the spring structure.

In another embodiment, a back support exoskeleton includes an energy return mechanism, wherein the energy return mechanism comprises at least one stack of leaf springs, where the at least one stack of leaf springs include one or more beams, wherein the beams can be positioned relative to each other to adjust overall length of the spring.

In another embodiment, a back support exoskeleton includes an energy return mechanism, wherein the energy return mechanism is comprises at least one spring structure, where, for each spring structure, there is an upper spring and a lower spring, and where the lower spring rotates relative to the upper spring with a hinge, to enable the overall spring structure to become shorter in length.

In another embodiment, a back support exoskeleton includes rigid elements that are covered with fabric.

### BRIEF DESCRIPTION OF THE DRAWINGS

FIG. 1 shows a rear facing view of an exoskeleton harness, in accordance with an embodiment of the present invention.

FIG. 2 shows a side profile view of an exoskeleton harness, in accordance with an embodiment of the present invention.

FIG. 3 shows a front facing view of an exoskeleton harness, in accordance with an embodiment of the present invention.

FIG. 4 shows an example diagram of an exoskeleton harness, in accordance with an embodiment of the present invention.

FIG. 5 shows varying views of an exoskeleton harness, in accordance with an embodiment of the present invention.

FIG. 6 shows an illustration of multiple spring elements of an exoskeleton harness, in accordance with an embodiment of the present invention.

FIG. 7 shows an example variation of a spring mechanism, in accordance with an embodiment of the present invention.

FIG. 8 shows an example diagram of a differential formed with two separate parts, in accordance with an embodiment of the present invention.

FIG. 9 shows an example diagram of upper and lower springs being held together with guides around them, in accordance with an embodiment of the present invention.

FIG. 10 shows example leg pad inserts, in accordance with an embodiment of the present invention.

FIGS. 11A and 11B show an rigid insert, in accordance with an embodiment of the present invention.

FIG. 12 depicts an arrangement of a differential strap and forces exerted with corresponding placement of the differential strap, in accordance with an embodiment of the present invention.

FIG. 13 depicts a configuration with a retaining loop at the back for a left limb, in accordance with an embodiment of the present invention.

FIG. 14 depicts another configuration with a retaining loop at the bag for a left limb, in accordance with embodiment of the present invention.

FIG. 15 depicts a configuration with a retaining loop at the back for a right limb that corresponds to the configuration with the retaining loop at the back for the left limb depicted in FIG. 13 in accordance with an embodiment of the present invention.

FIG. 16 depicts a leg pad with a loop on the back that can be incorporated into a back support exoskeleton, in accordance with an embodiment of the present invention.

FIG. 17 depicts an alternate view of the leg pad depicted in FIG. 17, in accordance with an embodiment of the present invention.

FIG. 18 depicts a differential strap attached to the center of a V-strap in a fixed, non-adjustable manner, in accordance with an embodiment of the present invention.

FIG. 19 depicts an alternate mechanism to adjust the length of the differential strap between the legs, in accordance with an embodiment of the present invention.

FIG. 20 depicts a V-strap with the rigid insert, in accordance with an embodiment of the present invention.

FIG. 21 shows a prototype of a V-strap where the differential strap is affixed to the center of the V-strap, in accordance with an embodiment of the present invention.

FIG. 22 shows an example of a V-strap with an alternate configuration, in accordance with an embodiment of the present invention.

FIG. 23 depicts incorporation of a V strap into an exoskeleton design, in accordance with an embodiment of the present invention.

FIG. 24 depicts a mechanism for adjusting a differential strap, in accordance with an embodiment of the present invention.

FIG. 25 shows various buckle placement on leg pads, in accordance with an embodiment of the present invention.

FIG. 26 illustrates interactions between the differential strap, cam buckle, and strap buckle, in accordance with an embodiment of the present invention.

FIG. 27 depicts a mechanism to adjust leg pad tightness, in accordance with an embodiment of the present invention.

FIG. 28 depicts a top view of the mechanism of FIG. 27, in accordance with an embodiment of the present invention.

FIG. 29 depicts integration of leg pads to soft exosuits, in accordance with an embodiment of the present invention.

### DETAILED DESCRIPTION

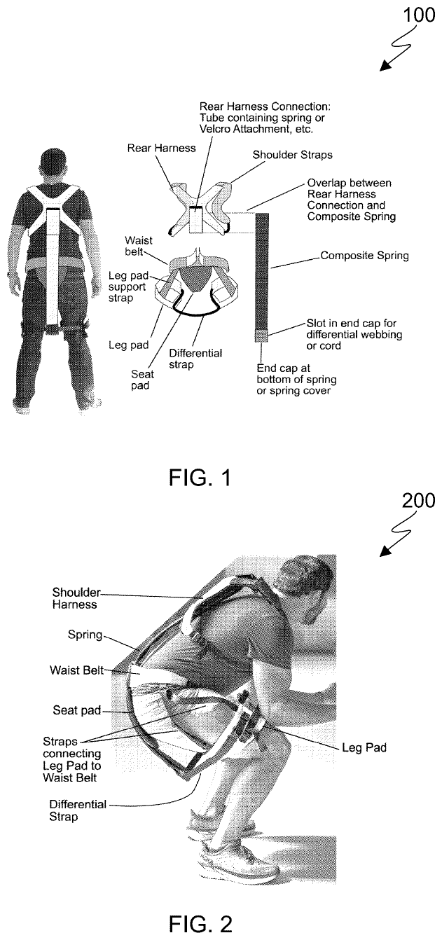

Within the set of back exoskeletons, one preferred embodiment is an unpowered (passive) exoskeleton, that uses one or more springs to create a force pulling the wearer up to a vertical posture. No external power source is used. One possible example of this embodiment is shown in example 100 depicted in FIG. 1. With this embodiment, the exoskeleton includes a shoulder harness, one or more leaf springs connecting from the shoulder harness downward to a point between their legs, and leg pads (also referred to as thigh pads). An optional waist belt can help support the exoskeleton and secure it to the wearer's body, and an optional Seat Pad can provide padding between the wearer's backside and the spring. The leg pads are connected to the waist belt by support straps, to hold them in the appropriate place on the wearer's legs and prevent them from falling down.

The leg pads are connected together and to the lower end of the spring with a differential strap. This differential strap can be a cord, cable, piece of webbing, or any similar tensile member. The differential strap passes through a channel (or slot) at the lower end of the Spring (which may be in an “end cap” attached to the spring), so that it is retained from escaping under normal operation. When the wearer leans their torso forward, the differential strap pulls forward on the spring. At the top of the spring, the shoulder harness pulls forward as well. Since the wearer's rear and backside pushes backward on the center of the spring, the Spring bends, creating a force that causes the wearer to straighten.

Importantly, the channel retaining the differential strap at the end of the spring can be a pulley, slot in a piece of slippery plastic, or any other similar means of having minimal friction between the strap and the channel retaining the strap, allowing the Differential Strap to slide back and forth easily. The reason the differential strap must slide back and forth is that during walking, a person moves one of their legs forward and one leg backward, at approximately the same angles. Thus, the differential strap can move within the channel, extending outward and forward on the side where the wearer moved their leg forward, and shortening on the side where the wearer moved their leg back. In this manner, the differential strap must slide within the channel easily, so that walking and other motions are not restricted.

FIG. 2 shows a side profile view of an exoskeleton harness, in accordance with an embodiment of the present invention.

Example 200 shows another view of an exoskeleton comprising a shoulder harness, a leaf spring, a waist belt, a seat pad, a differential strap, and leg pads. Here, it is visible how the spring has deformed to follow the wearer's thighs and back. The shoulder harness is pulling upward on the wearer's torso, and the leg pads are pulling downward against the wearer's thighs through the force of the differential strap. The lower end of the spring is being pulled upward by the differential strap. The middle of the spring is pushed into the wearer, and cushioning is provided by the seat pad.

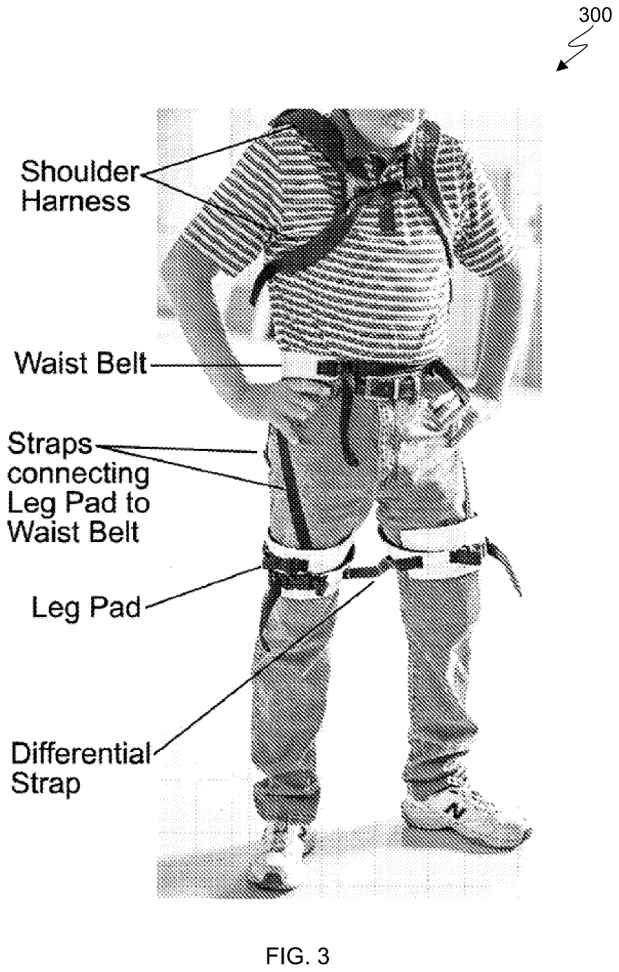

FIG. 3 shows a front facing view of an exoskeleton harness, in accordance with an embodiment of the present invention. Example 300 illustrates the front facing view of the exoskeleton harness which includes a shoulder harness, a waist belt, leg pads, straps connecting the leg pads to the waist belt, and a differential strap.

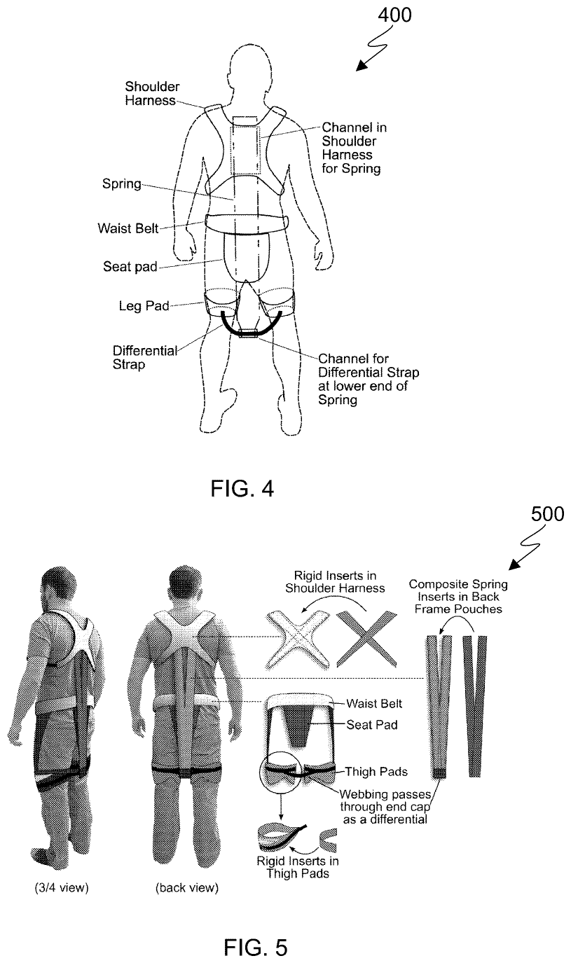

FIG. 4 shows an example diagram of an exoskeleton harness, in accordance with an embodiment of the present invention.

Example 400 presents another image of a full-body exoskeleton with a differential is the following. In this case, one option for the interface between the chest harness and the spring is shown more clearly: there is a tube-shaped pocket in the chest harness that allows the chest harness to slide up and down on the spring. This sliding behavior allows the device to pull more perpendicularly to the wearer's shoulders. Because the spring is positioned posterior to the wearer's hip, when the wearer bends the shoulder harness will tend to pull downward relative to the wearer's shoulders if the shoulder harness is rigidly attached to the spring.

Thus, permitting the shoulder harness to slide a small distance (2-6″, or 5-15 cm) relative to the spring allows the shoulder harness to move upward on the spring when the wearer bends, preventing it from pulling downward on the user's shoulders. The channel can be made of a slippery material, such as a plastic, fabric, or composite (designed to decrease friction between the material the spring is made from or contained in and the material of the shoulder harness). If the material is a plastic, it could be Teflon™, High-Density Polyethylene (HDPE), acetal, or any other slippery plastic. The spring can be covered with a fabric pouch to slide against this plastic channel, or can be covered with a similarly slippery plastic, or can just slide against the channel itself (note the spring is preferentially made of a flexible composite such as fiberglass or carbon fiber). Covering the spring with another material will prevent abrasion of the spring itself, which is beneficial.

All of the previous description is encompassed within the previous U.S. Pat. No. 10,870,198, “Back exoskeleton to assist lifting,” and is described here to provide a background for the present invention. The following include new aspects of the invention.

### Exoskeleton Enclosed in a Textile Covering

FIG. 5 shows varying views of an exoskeleton harness, in accordance with an embodiment of the present invention.

Example 500 shows another embodiment of an exoskeleton. This embodiment includes a shoulder harness (also referred to as chest harness) composed of textiles, with rigid (inflexible or substantially inflexible) inserts. These inserts could be made of aluminum, plastic, or a composite such as fiberglass, carbon fiber, another solid material, or some combination thereof. Since the force on the shoulder harness are pulling forward, having a chest harness that is rigid from the center (where the spring pulls back on it) to the parts where it begins to extend forward around the wearer (i.e., near the top of the shoulders and sides of the wearer) will reduce deflection of the chest harness.

The design below also shows composite springs that are enclosed in a pouch, where the pouch is composed of a textile or thin flexible plastic. Having the spring elements enclosed with a textile pouch provides a small amount of padding; many times, an exoskeleton must be worn in an environment with fragile objects or objects that can be easily scratched, such as automobiles or airplanes that can have their paint scratched. Providing some padding around the rigid parts of the exoskeleton allows the exoskeleton to be used safely in these environments. In both the back pouch and in the chest harness, the inserts (back spring or chest harness inserts) are secured in the enclosing textile chamber through zippers, Velcro®, or a similar closure system. By enabling these inserts to be removed, the exoskeleton soft goods can be easily washed in a regular washing machine.

The back spring(s) may be covered in a cloth, foam cover, rubber, latex, plastic, or other flexible material covering, or can be coated in a material, to prevent abrasion, or can be exposed. Having a covered spring provides protection for objects in the vicinity of the wearer such as painted surfaces that can become scratched through contact with rigid parts on the exoskeleton—the cover or coating makes the exoskeleton non-marring. If there is a spring cover, a channel or pulley for the differential webbing may be mounted to the outside of the spring cover instead of to the spring itself.

### Variations on the Spring(s)

It is beneficial to be able to adjust the length of the spring, for different height individuals wearing the exoskeleton. Adjusting the length also enables the ability to adjust the stiffness of the spring, to accommodate different weights of the wearer. Additionally, it would be beneficial to shorten the overall spring length for storage and transport. To do all of these, one possible solution is to stack multiple thin springs. By changing the number of layers in the stack, the stiffness can be adjusted. The thin springs (beams) can be arranged so that they only partially overlap each other, as illustrated below. By changing the amount of overlap, the overall length of the entire structure can be modified. This can be used to accommodate different heights of the wearer.

If the design has multiple beams in a stack, they must be secured together. This can be done by bands or guides that surround the entire stack. The bands can be formed from various materials each having benefits. Bands formed of Velcro®, can adjust in diameter to accommodate varying numbers of beams; bands formed from an elastic material such as rubber, can expand to hold different numbers of beams. Rigid bands formed from stiff materials could also be used if there are a fixed number of beams in the stack. Another option is for a spring cover to hold all of the beams together, potentially with Velcro® or straps attached to the spring cover that can be tightened around the bunch. Still other methods could also be used to secure the beams, such as a bolt passing through the entire stack and secured with a nut on the other side, or a spring-loaded clamp that surrounds at least three sides of the stack and clamps them together.

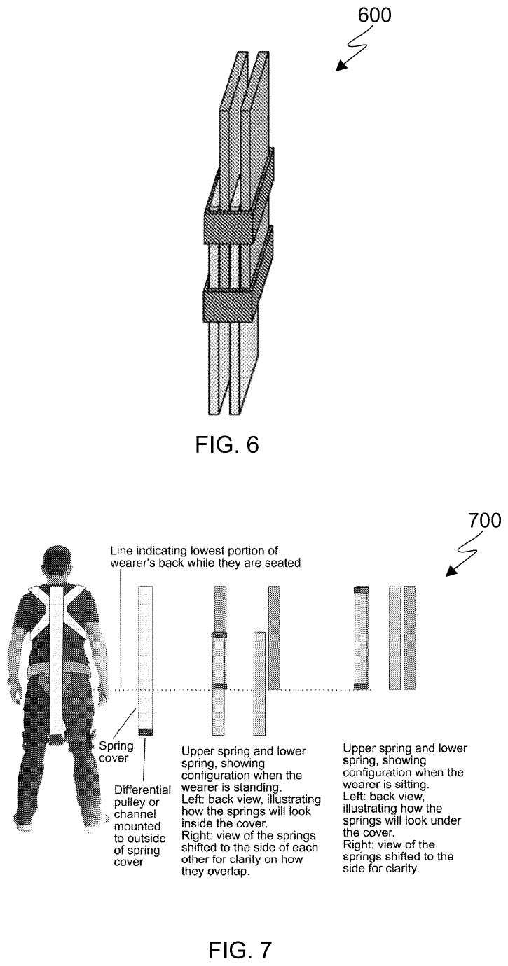

FIG. 6 shows an illustration of multiple spring elements of an exoskeleton harness, in accordance with an embodiment of the present invention. Example 600 shows two bands holding the stack of beams together; a single band could be used instead, or more than two bands. If the beams are enclosed in a pouch, a single band is all that is necessary since the band will serve to prevent them from slipping lengthwise, while the pouch will align them in the other directions. If a bolt and nut are used to secure the beams together, the beams would preferentially have a series of holes along the length of the beams or a long slot along the length of the beam. The bolt would pass through these holes (one hole in each beam) or through the slot. Some beams (e.g. the lower beams) could have holes, while the other beams (e.g. the upper beams) could have slots. A bolt and nut (or multiple bolts and nuts) would likely be more secure than bands, although would be more difficult to adjust.

Another variation of the spring is to make the spring in two halves, and these halves able to slide relative to each other to make the beam shorter. This is useful for shipping the spring, where a shorter package length may be easier and more cost-effective to transport. Additionally, this design would allow the wearer to sit down, e.g., in a chair or forklift or car.

FIG. 7 shows an example of a variation of a spring mechanism in two halves being able to slide relative to each other to make the beam shorter.

Design 700 includes two halves, each of which may be comprised of a stack of thinner beams. The two halves (referred to as the “upper spring” and “lower spring” in the pictures) are secured to each other where they overlap, but in a way that it is relatively easy for them to slide when the wearer wants to sit or collapse the spring for other reasons.

When the springs are slid to elongate the total length of the assembly, this configuration would be used for operating the exoskeleton, i.e., when a person needs to bend or lift objects. The springs can then slide to retract so they overlap each other more fully, which would shorten the total length of the assembly. The upper spring must be short enough that when the wearer is sitting, it does not extend downward past the horizontal plane of the chair. This height relative to the wearer is indicated in the drawing above by a horizontal dotted line, “Line indicating lowest portion of wearer's back while they are seated.” The design shown in the image above also shows the springs covered by a “spring cover,” which is a fabric or thin plastic enclosure. This enclosure does not need to retract when the springs are retracted; thus, the spring cover can hold the leg pads in the correct location relative to the wearer's body, even if the spring is fully retracted.

A cord could be connected to the top of the lower spring, and this cord could pass over the user's shoulder, giving them an easy way of pulling the lower spring upward to change the length. If there is a spring cover, the cord could remain inside the cover until it reaches the top of the cover, where it could come out a small hole in the cover. A second cord could also attach to the top of the lower spring, but be directed downward so the user can pull the lower spring down again to use the exoskeleton. If there is a spring cover, this could exit the spring cover in a small hole around the middle of the cover or the bottom of the cover. Since the top of the lower spring only moves downward to the mid-back region of the person, the hole only needs to be lower than this height.

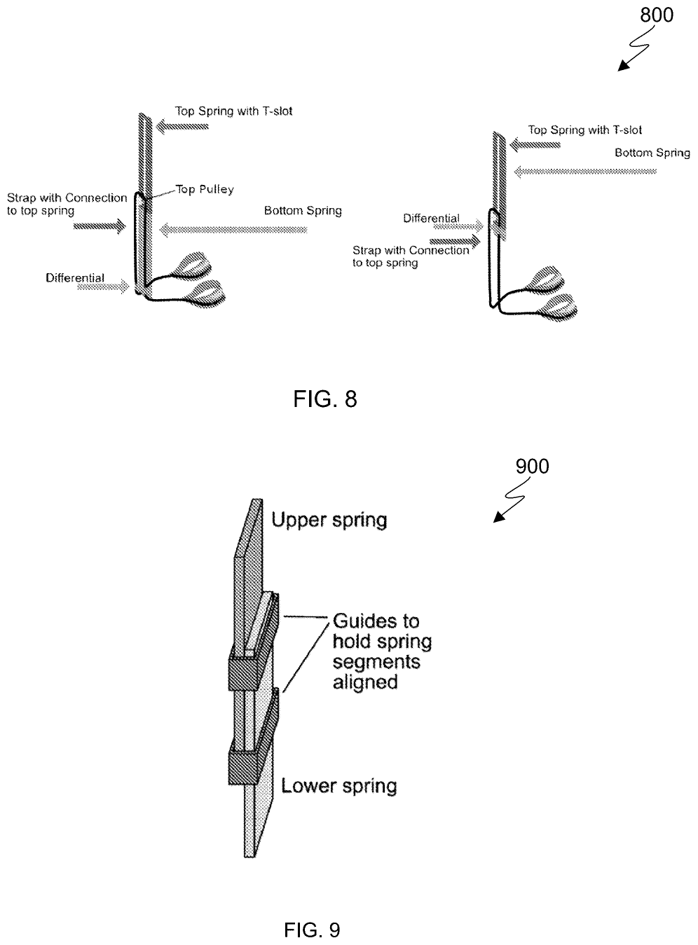

While FIG. 7 shows the differential is connected to the bottom of the spring cover, the differential could also be formed with two separate parts, shown in example 800 of FIG. 8. The bottom part of the differential (labeled “Differential”) has two pulleys or channels that redirect the Differential Strap to be vertical. Then, the bottom end of the Top Spring has a third pulley or channel (“Top Pulley”) that redirects the Differential Strap in the shape of an inverted “U.” When the upper spring and lower spring are collapsed, the distance between the lower two pulleys and the third (upper) pulley is shortened, giving more slack in the Differential Strap and allowing the wearer to move their legs more easily.

FIG. 9 shows an example diagram of upper and lower springs being held together with guides around them, in accordance with an embodiment of the present invention. Example 900 shows how the upper and lower springs may be held together with guides around them. These guides may be rigid, since they do not need to expand to hold different numbers of beams, or they could be flexible. The two parts (“upper spring” and “lower spring”) may each include several beams in each part, either stacked or next to each other. The beams may include a slippery material (such as Teflon™, high density polyethylene (HDPE), high molecular weight polyethylene (HMWPE), or other similar plastics) between the parts, so that they can slide up or down with respect to each other more easily. This slippery material may be over the entire length of the spring contact area, or may just be near the ends of each spring so as to minimize the material used. More specifically, if the slippery material is only near the ends of each spring, it would be located preferentially near the top of the lower spring and near the bottom of the upper spring. In this manner the slippery areas would remain in contact with the other spring as the beams moved relative to each other.

For example, each of the upper spring and lower spring could have a piece of plastic attached to the end, where the plastic has an opening in it that surrounds the other half of the spring. The plastic can be glued onto the stack of beams, secured to the stack with a nut and bolt, attached with a strap surrounding the half spring lengthwise, could pass through slots in the spring, or by other means. The means of securing them could also be with a textile such as a piece of webbing or piece of cloth. The textile would secure to one half of the spring and then include a loop that passes over the other half of the spring. The textile could attach to the spring by any of the afore-mentioned means. The two halves of the spring could also be retained next to each other by a single spring cover that extends over the entire spring assembly, without additional dedicated means of securing them at the ends of each spring.

Instead of the mechanism shown in FIG. 9, many mechanisms could be used instead other methods for translation could be applied, such as a peg protruding from one beam that is constrained in a slot on the other beam. It may be that the spring cover constrains the beams together well enough, and no additional mechanism such as a band is needed to hold them together. In this case, the spring cover should be very strong, because there will be a considerable force pulling the two parts of the spring apart.

With a design including a spring with an upper spring and lower spring where the lower spring can slide upward to allow the wearer to sit, the springs can preferentially be different thicknesses or widths as a function of their height along the body. Different thicknesses or widths will allow a portion of the spring to bend more easily than another part. Since the upper spring and lower spring overlap in the center of the wearer, making the upper spring thicker at the top end (starting near the area where the overlap with the bottom spring ends) would allow the total spring thickness to be approximately constant, so that the beam would undergo a more uniform bend as opposed to preferentially bending at the ends where there is no overlap.

Yet another method of shortening the spring is to use a hinge at around the midpoint of the spring. This hinge could rotate backward (so that it can bend in the opposite direction from the direction of flex when the user bends forward) but would be prevented from rotating forward, such that the beam must flex when the wearer bends as normal. This could be accomplished by, for example, having the lower spring on the side away from the wearer's body and the upper spring closer to the wearer's body. The lower spring could overlap with the upper spring by a distance of 3″-8″. The hinge could be located at the top of the lower spring, such that the overlap with the upper spring would prevent the lower spring from rotating forward.

A hinge could also be used to connect the two halves of the spring, where the axis of rotation points forward and backward with respect to the wearer's body. In this case, the two halves of the spring would rotate sideways relative to each other around a single pivot point. A connection guide/Velcro®, etc. would secure them in place when they are aligned, for normal use. Either of these hinge designs would allow the spring to be “collapsed” for transport or storage and may allow the lower spring to pivot out of the way allowing the wearer to sit down, although the leg pads may need to be removed to enable the user to sit.

### Rigid Inserts in Leg Pads

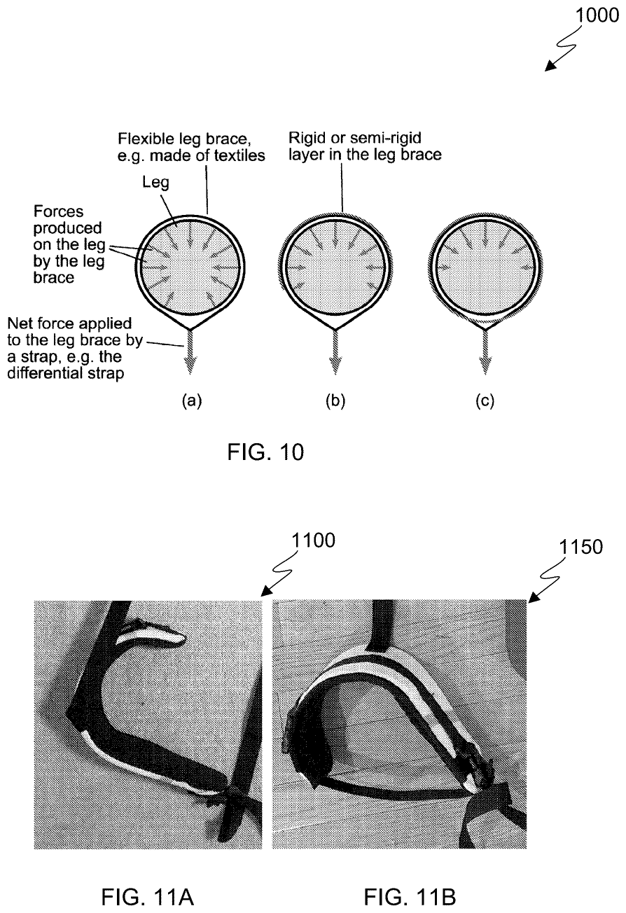

FIG. 10 shows example leg pad inserts 1000, in accordance with an embodiment of the present invention. The leg pads (also referred to as leg braces) can be preferentially designed with an insert that is rigid or semi-rigid. This has two benefits. First, it reduces the forces squeezing the wearer's leg. FIG. 10, part (a) shows a leg pad comprised of a textile. The leg pad is pulled backward at a single point, indicated by an arrow in the picture. Since the pad is made of a flexible textile, it will apply an inward force all around the leg except in the very back where it has pulled away from the leg. Since the tension in the textile is approximately constant around the leg, and the friction forces with the leg are small, the inward forces are generated wherever there is a bend in the textile. This device is suboptimal because the wearer's leg is squeezed from all directions; the leg is squeezed in the left-right direction, which does not contribute to supporting the net backward force on the leg. Additionally, there are small forces pushing forward on the leg (shown as upward FIG. 10). These forces must be countered by additional backward forces at the front of the leg (shown as downward in FIG. 10) since there is already a high pressure at the front of the leg resisting the backward force from the strap, these additional forces may cause discomfort to the wearer. Thus, many of the forces created by a textile are internal forces that serve no functional purpose, but instead can bother the wearer.

An alternative is to place a rigid or semi-rigid layer in the leg brace, such as is shown in parts (b) and (c) of FIG. 10 (indicated by a thick line on the outside of the leg pad). This layer could be comprised of aluminum, e.g., 1/16″ thick aluminum, or by plastic such as acetal, high-density polyethylene (HDPE), nylon, or other plastics. The thickness of these plastics can preferentially be between 1/32″ to ⅛″, as this thickness range is enough to distribute forces but still allow the leg pad to conform to different leg sizes. Thinner or thicker plastics could also be used, however; thinner plastics could be contoured in a way to make them more rigid in bending, which may save material costs. Thicker plastics may distribute the force better but at the cost of additional weight. For aluminum, 1/16″ is a preferred thickness because it is thick enough to hold a shape and distribute forces, but thin enough that a user could manually reshape the leg pad to fit the shape of their leg, which may be needed if they have a leg diameter that is much larger or smaller than a nominal leg pad diameter. Again, other thicknesses could be used as well.

In part (b) of FIG. 10, the rigid or semi-rigid layer extends over the front ⅔ of the leg pad. In this case, the forces pushing inward on the leg are substantially reduced. Part (c) of FIG. 10, the rigid or semi-rigid layer extends all the way around the wearer's leg. In this case, the forces pushing inward or backward on the leg are even more reduced. Thus, while any amount of rigid or semi-rigid layer is beneficial, it is most beneficial if the layer completely surrounds the wearer's leg.

Another benefit of a semi-rigid or rigid layer completely surrounding the leg is that it allows the leg pad to be attached to the wearer's leg more easily. The leg pad must be secured around the leg, or the wearer must step through the leg pad. However, it is bothersome to step through a leg pad, making a design that can be secured around the leg much more preferable. To don such a pad, the wearer must wrap the pad around their leg then secure it closed. If there is a differential strap in the back, the pad must be initially positioned behind the wearer's leg, and then wrapped around their leg toward the front or side of their leg and secured there. Part of the pad must pass between the wearer's legs. If the plastic holds the shape of the leg pad in a roughly circular manner, the wearer can grab the part of the leg pad between their legs more easily than if the pad was comprised of a flexible textile. The wearer can then hold the front part of the pad and the part that extends between their legs, and then attach them together. Thus, the inclusion of a semi-rigid or rigid layer in the pad makes putting on the leg pad much easier.

Another benefit of a rigid or semi-rigid layer in a leg pad is that it can hold the leg pad in place while the wearer puts on the exoskeleton. With a back exoskeleton configuration with a leaf spring, if the shoulder harness is put on before the leg pads, then the leg pads will tend to pull away from the wearer behind them if the wearer bends forward during the donning process. This makes securing the leg pads around the legs difficult, since they are out of reach of the wearer. One solution to this is for the leg pad to be hooked around the front of the wearer's leg while they are donning the exoskeleton. Then, even if the leg pad is not fastened around their leg with a strap (i.e., it does not completely surround their leg), the leg pad can support backward forces from the spring. In this case, the inside of the leg may be just a webbing strap or other very flexible piece of fabric, and is not required for transmitting forces. Such a flexible piece of webbing or fabric may be thinner than a piece of fabric with a rigid or semi-rigid insert; thus, it may be less likely to contact the wearer's other leg while they are walking, particularly for individuals who have thighs that are close together.

FIGS. 11A and 11B show an example of a leg pad that has a rigid insert and can be hooked around the wearer's leg. More specifically, FIG. 11A shows leg pad 1100 with an aluminum insert along its entire length. The aluminum insert holds the leg pad in the hooked shape. There is a strap extending from the lower right end of the leg pad that is a differential strap, and a second strap extending from the lower right end of the leg pad that secures the pad around the wearer's leg. FIG. 11B shows example 1150 which depicts the same leg pad (e.g., leg pad 1100) but with the strap securing it around the wearer's leg fastened. The differential strap exits the picture as depicted in FIG. 11B.

### Loop at the Back of the Leg Pad to Allow the Differential Strap to be Positioned at the Side of the Pad

A person may wish to adjust the length of the differential strap when initially putting on the exoskeleton, or to tighten or loosen the exoskeleton for different activities. For example, if a person will be remaining in a deep squat position for an extended period of time, they may wish to loosen the exoskeleton so there is less of a force from the exoskeleton on their torso or legs. When they return to normal walking and bending, they may wish to tighten the exoskeleton again so it provides more force.

In order to adjust the differential strap between the legs, while maximizing the available distance at the back of the leg, it is necessary to provide a means to adjust the differential strap that is located on the side or front of a leg pad. The alternative to adjusting the differential strap at the side or front of the leg pad is to adjust the differential strap with a fixture located at the back of the pad, where the differential strap attaches to the leg pad. But this location is not ideal for multiple reasons. First, it is difficult for a wearer to reach. Second, if there is any tension in the differential strap when it is adjusted, it is very difficult to apply forces in the direction necessary to adjust the differential strap. Third, if there is a buckle at the back of the leg used to adjust the differential strap, this will press into the back of some users' calf muscles when they do a deep squat. This will press into their leg in a manner that is uncomfortable.

Finally, if the buckle is at the back of the leg pad, the buckle itself will also take some of the space between the leg pad and the spring, effectively shortening the available length of the differential strap and reducing the distance for walking without either pad running into the channel in the middle.

Thus, it is desirable to provide an adjustment for the differential strap that is located at the front of the leg or side of the leg. This is in easy reach for the wearer, and moves the bulky buckles out of the way of the back of the leg. However, it is not obvious how to do this. If the differential strap is simply connected to the side or front of the leg, then it will pull on the pad from that point. Placing tension on this point will twist the leg pad around on the leg.

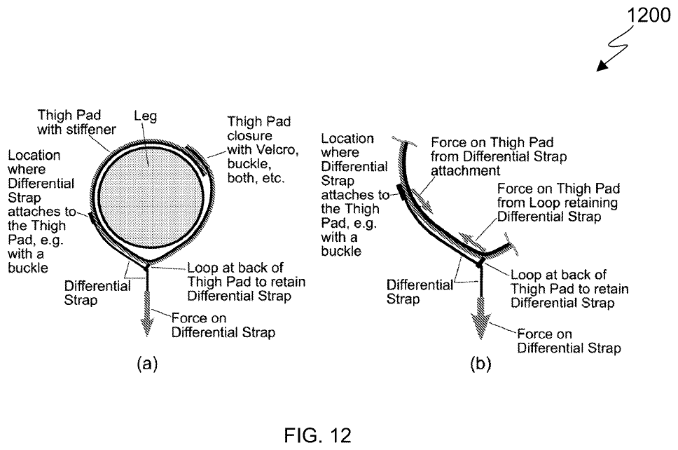

FIG. 12 depicts example 1200 which illustrates an arrangement of a differential strap and forces exerted with corresponding placement of the differential strap, in accordance with an embodiment of the present invention.

To put the differential strap adjustment on the front or side of the leg, the best method of doing this is to use a Loop on the back of the leg pad. The webbing strap passes through this loop and then continues to the front or side of the leg, where it is secured by a buckle or other means (including Velcro®, Boa cable winder, etc.). The differential strap now is pulling at the back of the leg, but is not secured to the leg pad until it reaches the front or side of the pad. This arrangement is shown in FIG. 12, part (a).

While placing a loop at the back of the leg pad will work by itself, this arrangement will tend to squeeze the leg with the differential strap when loads are applied to it. The forces on the leg pad with a loop at the back are shown in FIG. 12, part (b) in the image above. As can be seen there, since the differential strap connects to the side of the pad, it will pull the pad forward from that point. However, the loop will also have a force, which will pull outward from the thigh strap at an angle halfway between the angles of the differential strap on the two sides of the loop (downward and to the left in the figure). This force pulls on the leg pad main structure, since the loop is attached to it there. The “Force on thigh pad from loop retaining differential strap” is the component of this force parallel to the leg pad, which opposes the force from where the end of the differential strap attaches to the leg pad. Thus, there is a compressive force along the length of the leg pad between the loop and the point where the differential strap attaches.

To prevent the leg pad from compressing or buckling from this force, the leg pad should preferentially contain a piece of metal, plastic, or other rigid or semi-rigid insert or layer such as foam so that it does not compress. With this rigid or semi-rigid insert or layer, the leg pad will hold its shape and not compress around the wearer's leg. We note that this rigid or semi-rigid layer could be the same layer as a rigid or semi-rigid layer holding the shape of the leg pad to distribute the forces around the wearer's leg in a preferential manner.

We further note that only one of the leg pads needs to have a mechanism to adjust the length of the differential strap; the other leg can have the differential strap sewn onto the back of the leg pad, so it is not adjustable there. The downside of this is that a user must always use the same hand to adjust the differential length. However, people are typically either right-handed or left-handed, and so using the same hand may not be problematic

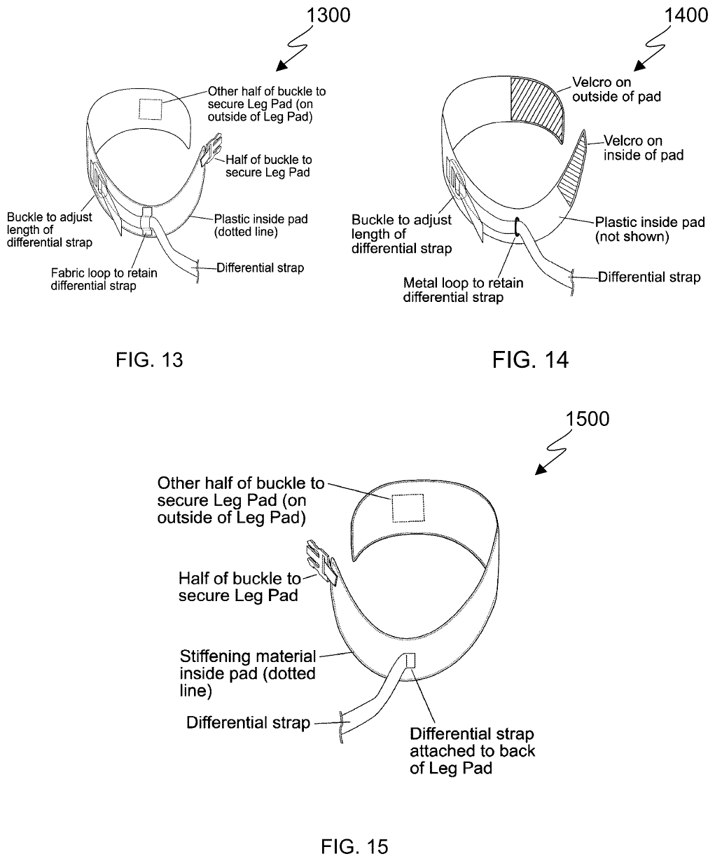

FIG. 13 depicts a configuration with a retaining loop at the back for a left limb, in accordance with an embodiment of the present invention. Example 1300 shows an embodiment of a leg pad with a retaining loop at the back. In this embodiment, the retaining loop is a fabric loop, sewn onto the leg pad; in general, the retaining loop could be made from plastic or metal. As indicated in the drawing, this example has a plastic insert inside the pad that extends around the back of the wearer's leg. This plastic shape can be pre-formed to stay away from the wearer's leg at the back of the leg, thus ensuring that the forces pull more or less backward on the leg (since the back part of the pad may not be contacting the wearer's leg). The half of the pad with the buckle (right side of the pad) will stick between the wearer's legs, so having a rigid or semi-rigid layer will help the wearer grab onto the buckle as they are donning the exoskeleton. The female side of this buckle is located on the front of the pad (labeled “Other half of buckle to secure Leg Pad”). On the left side of the leg pad, a “Buckle to adjust length of differential strap” is a strap buckle (also called a ladder lock buckle). This can be adjusted by the user to shorten or lengthen the differential strap, and it will hold the strap in position once adjusted.

FIG. 14 depicts another configuration with a retaining loop at the bag for a left limb, in accordance with embodiment of the present invention. Example 1400 shows another possible embodiment of the leg pad with a loop on the back. Here, a metal loop is attached to the leg pad with a short piece of webbing (not shown in the figure). This short attachment piece of webbing passes through the loop, then is sewn down to the leg pad on either side of the loop. This embodiment also shows an alternate way of fastening the leg pad: Velcro® is used on the two sides of the pad, so they can be placed against each other and secured to attach the pad to the wearer's leg. Alternatively, multiple alternating layers of Velcro® could be used to increase the holding force and provide additional security to the leg pad.

FIG. 15 shows the matching leg to either leg pad depicted in either FIG. 13 or 14, that is FIGS. 13 and 14 depicted the left leg pad, while FIG. 15 shows the right leg pad. Example 1500 depicts an embodiment that illustrates how the differential strap can be attached directly to the back of the leg pad, if the other leg pad has a mechanism for adjusting its length. Since the differential strap connects the two legs, it only needs to be adjusted at a single location. That is, tightening or loosening it at one leg will affect the total length between the two leg pads. The pad that allows adjustment can be either the right or left leg pad, or even both. The pad that does not allow adjustment can be opposite to a leg pad that allows adjustment.

FIG. 15 shows how the stiffening layer (plastic in this case) extends over the entire area of the leg pad. To cushion the wearer from the plastic or other rigid or semi-rigid insert, the layer of the leg pad on the user side of the plastic can contain 3D mesh, foam, or other squishy soft, deformable material. It may be that only a textile layer (e.g. nylon or polyester cloth) can provide sufficient padding for the user. Having a soft, deformable layer on the user side (inside of the leg pad) of the rigid or semi-rigid layer will prevent the edge of the rigid or semi-rigid layer from putting high pressure on the wearer's leg. Alternatively, the edge can be rounded (curling away from the user's body around the entire perimeter) to form a smooth surface that can press against the user without a sharp edge.

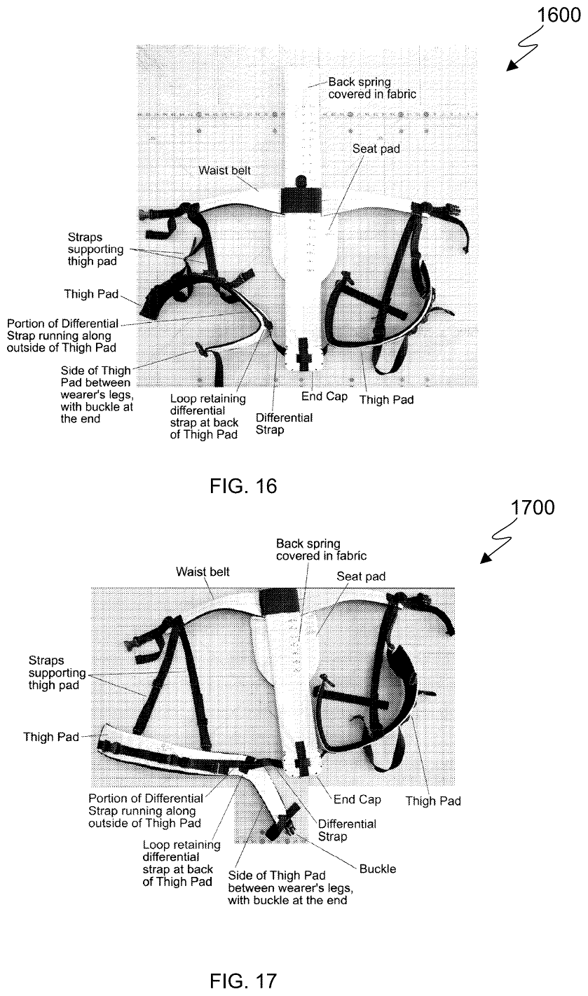

FIG. 16 shows example 1600 which illustrates how a leg pad with a loop on the back can be incorporated into a back support exoskeleton. In FIG. 16, the shoulder harness is not shown; this would connect to the top of the “back spring.” In the embodiment, the Differential Strap passes through the End Cap at the lower end of the spring. There are loops (labeled “Loop retaining differential strap at back of Thigh Pad”) at the back of the Leg Pads (labeled “Thigh Pad” in the picture) where the Differential Strap passes through. The Differential Strap then terminates on the side of each leg pad with a strap buckle.

FIG. 17 shows example 1700 which depicts the lower half of the exoskeleton depicted in FIG. 16 in more detail. It shows half of the click buckle at the far right end of the leg pad (labeled “Buckle”), as well as the other half of the click buckle at the left end of the leg pad (unlabeled).

### V-Strap at the Back of Leg Pad

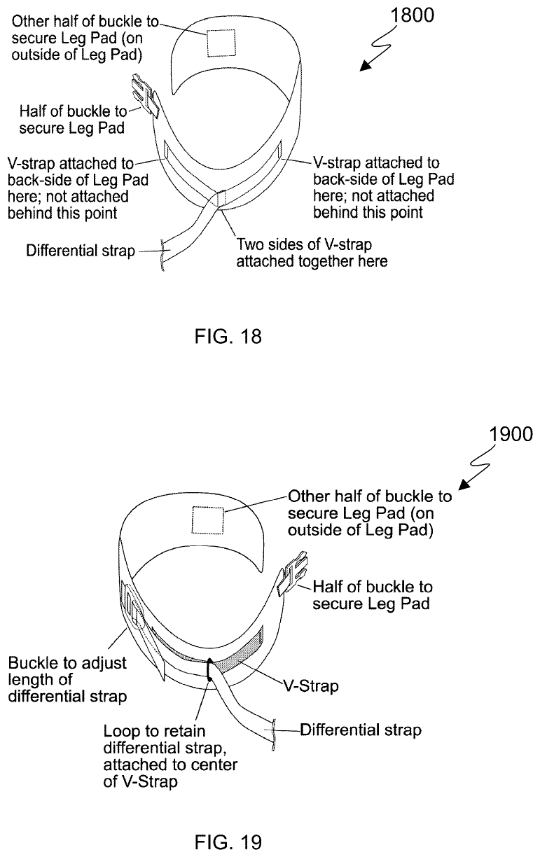

Another feature that is beneficial to have on a leg pad is a V-shaped strap attached to the back of the leg pad. This is a strap that does not attach to the center of the back of the leg pad, but instead attaches some distance (e.g., 2″-6″) on either side of the center of the back of the leg pad. This is illustrated in the FIG. 18. Example 1800 shows that the V-Strap is attached to the leg pad (e.g., sewn on) at the sides, and then floats freely over the back of the leg pad. It has two halves, which connect together at a point which is at the center of the back of the leg pad. The differential strap is connected to this point at the center of the V-Strap, which is located at the center of the back of the leg pad.

There are several purposes of this V-strap. First, if the differential strap attaches to the sides of the leg pad, it pulls on the front of the leg pad in a direction that is more toward the rear of the person. Restated, the two sides of the V-strap can pull in essentially straight lines from where it connects to the leg pad to the center point where they connect to the differential strap. Compared to pulling from a single point in the back of the leg pad, this will “squish” the wearer's leg inward less. This will reduce unwanted forces around the leg. This V-strap can be used with either an entirely soft leg pad (e.g., out of textiles) or with a leg pad with a semi-rigid or rigid layer. The benefits of the forces pulling more in a backward direction are most useful when the leg pad is made out of a flexible textile, because then there is no semi-rigid or rigid layer to distribute the forces in a beneficial pattern.

The second purpose of the V-strap is to maximize the leg motion permissible before the back of the leg pad runs into a leaf spring extending down behind the wearer's legs. If there is no V-strap, and the leg pad is worn loosely on the wearer's leg, then the leg pad will elongate and extend away from the wearer's leg some distance behind them. The forces on the pad are pulling the center of the pad backward very strongly, which will tend to cause the leg pad to adopt a tear-drop shape where the point is backward, toward the spring. In this case, if the wearer moves their leg backward, at some point the back of the leg pad will bump into the leaf spring. This can cause the leg pad to rotate around the wearer's leg while they are walking, potentially causing chafing against the user's leg. With a V-strap, the leg pad will remain round and will not extend backward, since the forces are pulling from the sides where the ends of the V-strap attach to the pad. The V-strap is made out of a flexible webbing, cord, or other similar soft and flexible material (even textile fabrics). Since these are flexible, when the wearer moves their leg backward, the V-strap will deform and collapse when the wearer's leg gets close to the spring. This presents virtually no resistance, and thus the leg pad will not bump into the spring and will not rotate or chafe on the wearer's leg. With a fixed differential length, or some means of adjusting the differential strap, the V-straps as drawn in the figure above can be used on both legs.

One possible other means of adjusting the effective length of the differential strap is to have two pulleys or channels on the end of the leaf spring that redirect the differential strap up along the spring, and a third pulley or channel higher up on the spring. This third pulley can be moved to different heights, for example with an additional strap pulling it upward and a strap buckle mounted to the spring. If the additional strap is tightened via the strap buckle, the third pulley will be moved upward on the spring and held in place due to the strap buckle. This will shorten the length of the differential strap that extends between the bottom of the spring and the leg pads, since some of the middle of the differential strap is now vertically along the spring instead of between the end cap and the leg pads.

While FIG. 18 shows the differential strap attached to the center of the V-strap in a fixed, non-adjustable manner, it is also beneficial to adjust the length of the differential strap between the legs. A method to accomplish this is shown in FIG. 19 which depicts an alternate mechanism 1900 to adjust the length of the differential strap between the legs, in accordance with an embodiment of the present invention.

In this embodiment, the center of the V-strap secures a loop that retains the differential strap, i.e., the loop is affixed to the center of the V-strap, and the differential strap passes through the center of this loop. As with the designs without the V-strap, this loop allows the differential strap to pull from the back of the leg pad, but continue to the side or front of the pad before it is affixed to the pad. In the figure below, a strap buckle is used to secure the differential strap to the side of the leg pad. Additionally, one side of the V-strap (specifically, the side of the V-strap where the differential strap passes over it) should preferentially be reinforced with plastic or some other rigid or semi-rigid element so that it does not buckle when force is applied to the differential strap. As before with the non-V-strap designs, the use of a loop through which the differential strap passes creates a compressive force between that point and the point on the pad where the differential strap terminates. In this case, the V-strap is in the path of that force, and so must be made inflexible enough to support that compressive force. If the V-strap is very tight against the pad, then it may be that the loop pushes against the leg pad and is held from moving further by the other side of the V-strap (e.g., moving towards the right side of FIG. 19). However, in most circumstances the V-strap should be strengthened, since the V-strap should have a small amount of clearance with the leg pad in order to move appropriately.

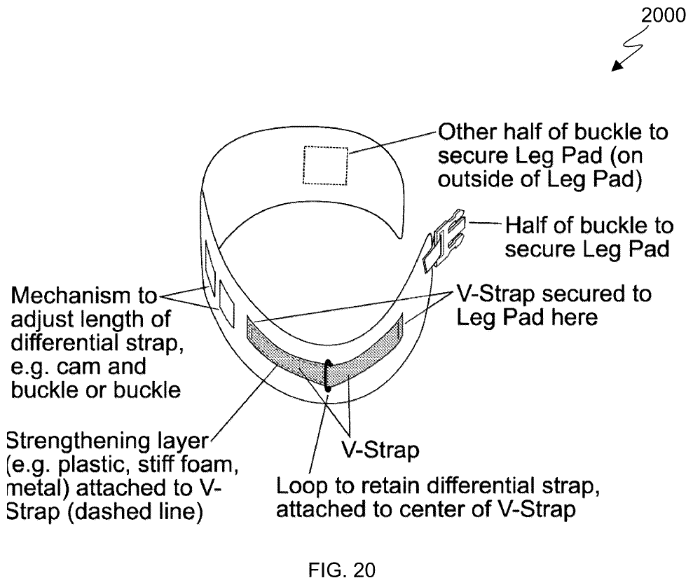

FIG. 20 shows example 2000 which shows more detail about the V-strap with the rigid insert, in accordance with an embodiment of the present invention. The picture is the same as the above picture, except the differential strap has been removed for clarity. In the picture below, the dashed outline on the left side of the V-strap indicates the location where the V-strap would be strengthened with a rigid or semi-rigid element. Note that the right half of the V-strap does not need a strengthening layer, since the forces serve to extend that side of the V-strap.

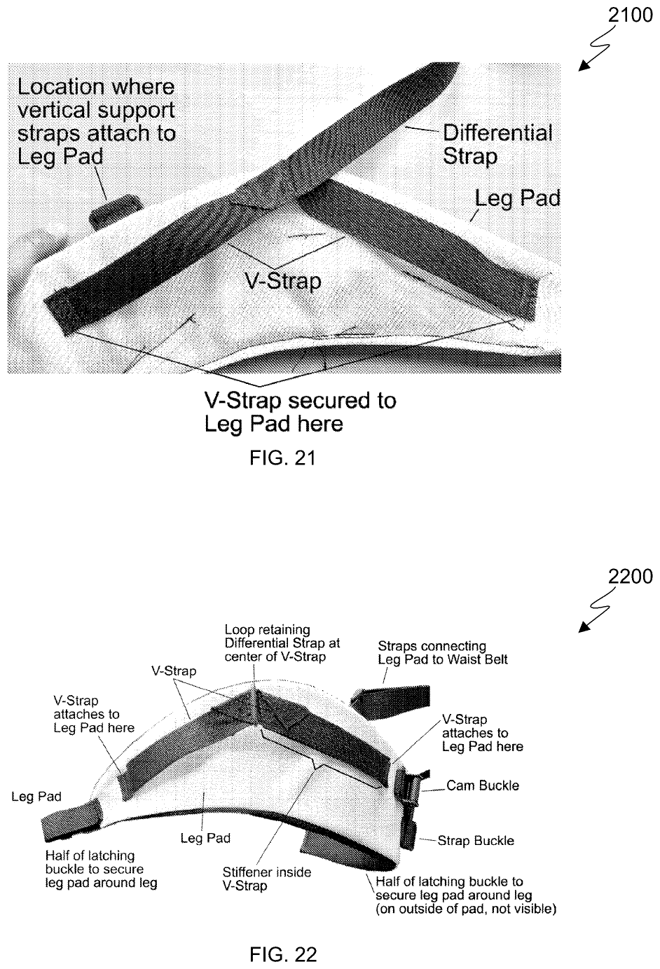

FIG. 21 shows example 2100 which depicts a practical embodiment of a V-strap where the differential strap is affixed to the center of the V-strap and cannot be adjusted in length on this pad, in accordance with an embodiment of the present invention.

FIG. 22 shows example 2200 which depicts a V-strap, but now with a loop attached to the center of the V-strap. Example 2200 shows the differential strap would enter the loop from the left side, exit on the right side, and continue to the cam buckle, which secures it to the leg pad. After the strap passes through the cam buckle, it continues to the strap buckle, securing it to the pad and allowing for easy adjusting. The right side of the V-strap is under the differential strap, and thus is strengthened with a rigid material. In this case, a piece of 1/16″ HDPE plastic is sufficient to strengthen the side of the V-strap. Another piece of webbing is sewn onto the bottom of this piece of plastic, adding to the rigidity of the structure.

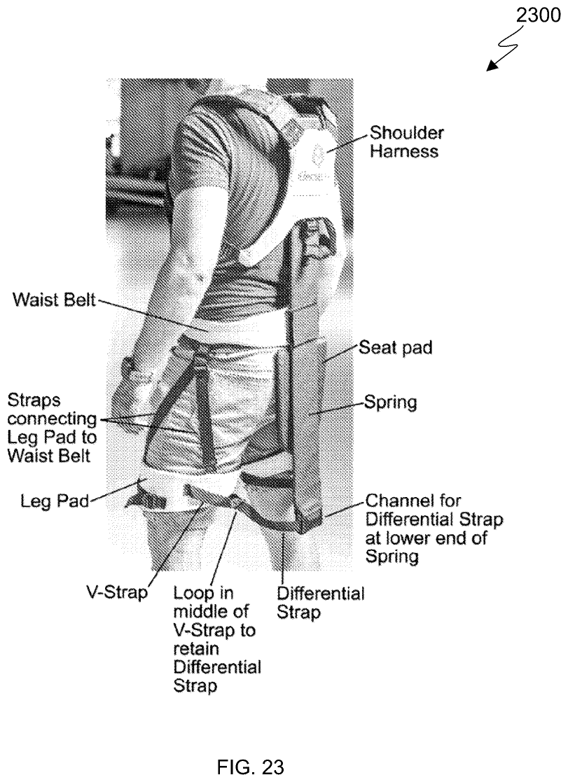

FIG. 23 depicts incorporation of a V strap into an exoskeleton design, in accordance with an embodiment of the present invention. Example 2300 depicts a shoulder harness, a waist belt, and a seat pad. The V strap and loop in the middle of V strap to retain the differential strap along with the differential strap and channel for the differential strap at the lower end of the spring, where the differential strap connects the left and the right leg pads is shown.

### Mechanism for Tightening or Loosening the Differential Strap

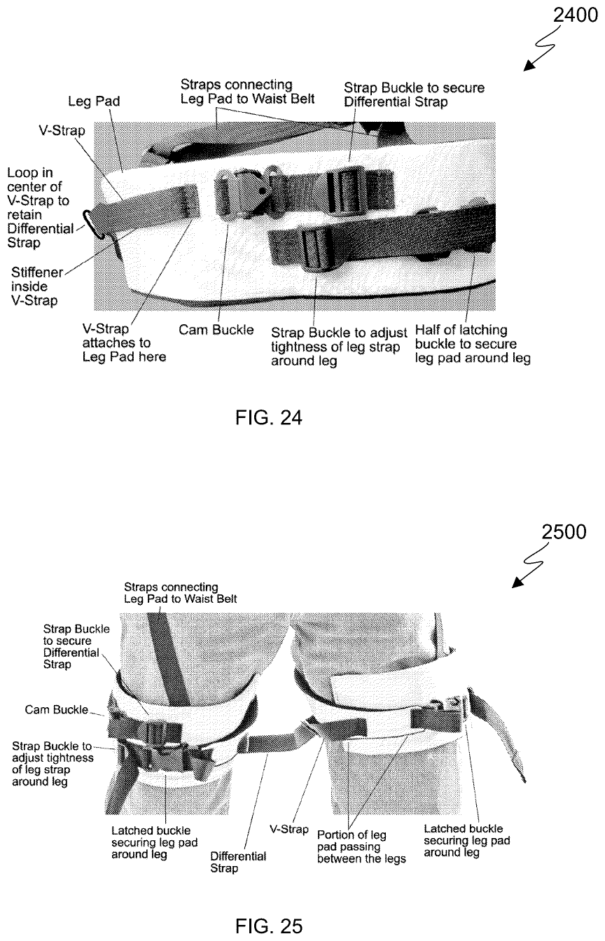

One method of securing the Differential Strap and tightening or loosening it is to use a combination of a spring-loaded cam buckle and a strap buckle, shown in the image below. In this case, the cam buckle is a device that will tighten and hold when tension is applied. In FIG. 24, example 2400 depicts the strap passing under the triangular-shaped top of the buckle. If the strap is pulled to the left in the picture, the triangular-shaped top element will rotate, using the spring-loaded cam buckle, to automatically tighten the grip on the strap. If the strap is pulled to the right, it can move freely because the triangular-shaped top lifts up. Note that the triangular-shaped top of the cam buckle is spring-loaded so it tends to rotate towards the strap lightly.

The strap buckle is a standard buckle, also known as a ladder lock, that is in series with the cam buckle. The differential strap (not shown in the image below) continues after passing through the cam buckle, and then secures to the strap buckle in the typical fashion.

With the series combination of the strap buckle and cam buckle, the user can easily and safely tighten and loosen the differential strap, even if it is under tension. To tighten the differential strap, the user holds onto the end of the strap after it comes out of the strap buckle, and lifts it upward and to the right in FIG. 24. The strap buckle is sewn onto the pad with a short webbing strap around its right side, such that it can rotate around its right end. When a user lifts up the end of the strap coming out of the strap buckle, this acts as a “ratchet” and pulls the entire differential strap through the cam buckle. When the user lets go, the cam buckle holds the differential strap in place. Then, the user can pull on the end of the differential strap and tighten it within the strap buckle. The user can repeat this series of operations to tighten the differential strap.

To loosen the differential strap, the user first lifts up the triangular plastic end of the strap buckle (shown on the left side of FIG. 24), which loosens the webbing through it. However, the cam buckle still holds the differential strap in place. The user can then lift the triangular-shaped top of the cam buckle, which releases the differential strap. At this point, the differential strap will pull to the left if there is any tension in it due to the spring. However, the differential strap can only extend a small distance, because the strap buckle prevents it from moving any further. The user can repeat these operations to loosen the differential strap in additional small stepped increments.

This mechanism is important for the safe operation of the exoskeleton. If only a strap buckle is used to secure the end of the differential strap, it is very difficult to tighten the differential strap if there is any tension in the strap. Adding the cam buckle in series allows a user to perform the ratcheting motion, which gives the user a mechanical advantage in tightening the strap. Additionally, the cam buckle in series makes the differential strap safe to loosen. If there is no cam buckle, when the strap buckle is rotated upward (opened), there is very little resistance to the differential strap pulling out from the strap buckle. A hard stop on the end of the differential strap (e.g., by folding it over several times and sewing it, so it is too large to fit through the strap buckle slots easily) can prevent it from coming out all the way, but it can still loosen a large amount in an uncontrolled manner. The cam buckle and the two-stage loosening process (loosening the strap buckle and then the cam buckle) allow the user to loosen the differential strap a small amount at a time, without it moving quickly and coming all the way out.

FIG. 25 shows example 2500 which depicts more detail about the positions of various buckles on the leg pads, specifically how the pad wraps around the leg and how the cam buckle can be placed in series with a strap buckle to secure the differential strap. This image shows the differential strap installed in the cam buckle and strap buckle, with the end of the strap protruding from the strap buckle.

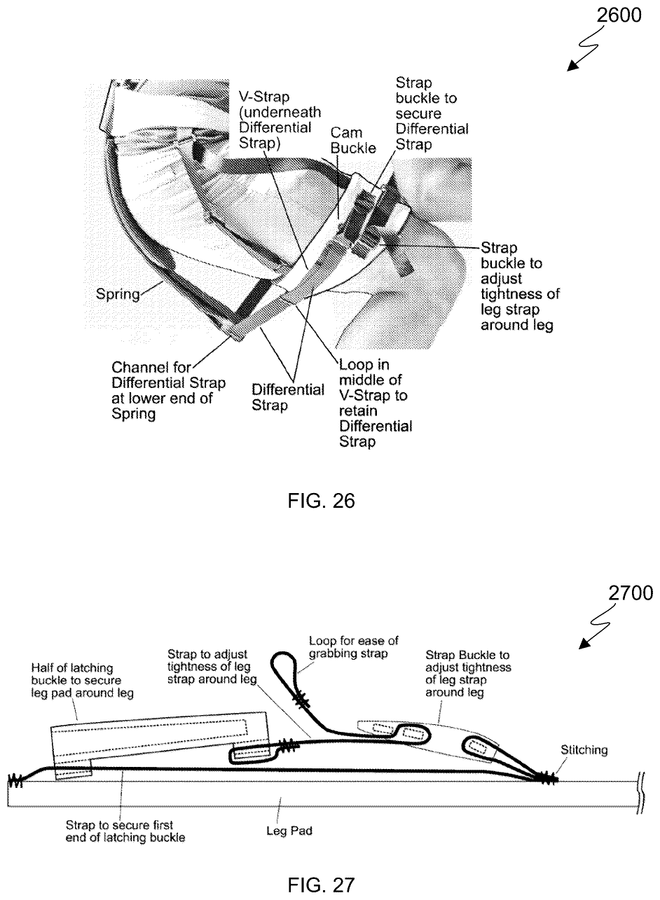

FIG. 26 shows example 2600 which illustrates how the Differential Strap sits over the V-strap and secures to the side/front of the pad with a cam buckle and strap buckle. This image also shows how the differential strap is installed in the cam buckle and strap buckle. The top edge of the V-strap can be seen underneath the differential strap. We note that the part of the V-strap covered by the differential strap has the stiffener installed, since the differential strap is causing compression in that portion of the V-strap.

### Mechanism for Adjusting Leg Pad Tightness

The leg pads of an exoskeleton or exosuit can include a mechanism to adjust their tightness around the leg. It is beneficial to buckle the leg pad around the wearer's leg with a buckle that can be clicked shut, so that the buckle can be quickly fastened, and so the leg pad can be adjusted to a specific size (diameter) and quickly and repeatedly donned to that same diameter. An alternative to this is to secure the leg pad with Velcro®, where it may have a different diameter each time the wearer puts it on and off. Yet at the same time, it is beneficial to be able to adjust the diameter of the leg pad, because different wearers will have different diameters of legs.

FIG. 27 shows example diagram 2700 which shows a mechanism to adjust leg pad tightness, in accordance with an embodiment of the present invention One mechanism to do this is to use a click buckle (also referred to as a latching buckle) in combination with a strap buckle (also called a ladder lock buckle). To do this, one end of the click buckle is secured to the leg pad with a channel at its end passing around a piece of webbing (shown in FIG. 27). This piece of webbing is itself secured to the leg pad. With this construction, the click buckle is able to slide back and forth over the piece of webbing. The other end of the click buckle is secured to a second piece of webbing. This second piece of webbing passes through a strap buckle. If the wearer tightens the webbing through the strap buckle, it will pull on the click buckle and tighten the pad around the wearer's leg. Alternately, the strap buckle can be loosened, which then allows the click buckle to slide in the other direction (shown left in FIG. 27) along the pad and loosen the pad.

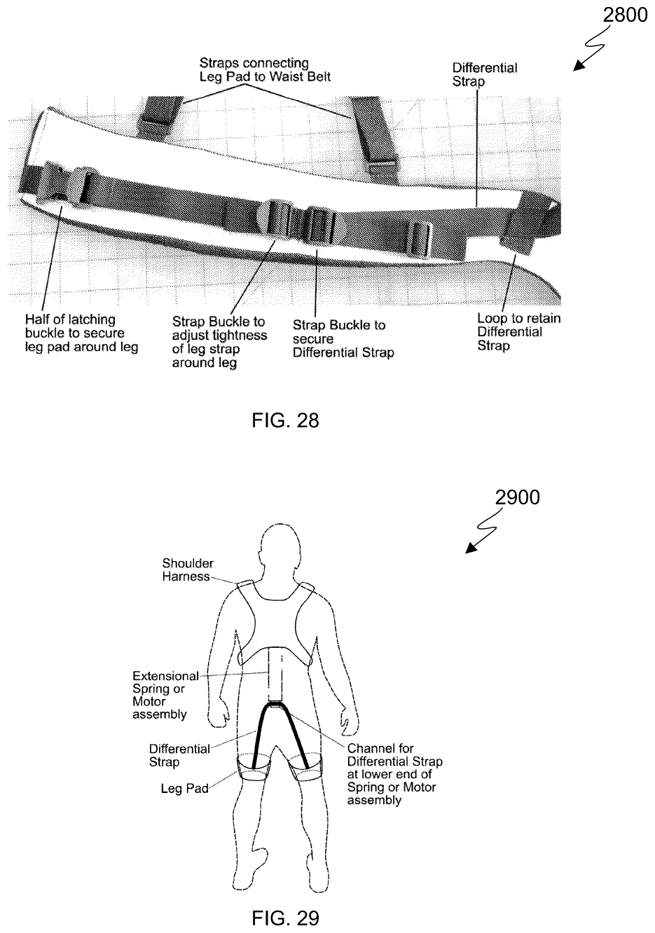

FIG. 28 depicts a top view of the mechanism (e.g., example 2800) of FIG. 27, in accordance with an embodiment of the present invention. In this example, straps connecting the leg pad to waist belt are shown as well as the differential strap, half of latching buckle to secure leg pad around leg, a strap buckle to adjust tightness of leg strap around the leg, a strap buck to secure the differential strap, and a loop to retrain the differential strap are shown.

### Application to Soft Exosuits

FIG. 29 depicts an example illustration 2900 which shows integration of leg pads to soft exosuits, in accordance with an embodiment of the present invention.

The preceding inventions related to leg pads can also be used with a soft exosuit, as shown in the picture below. A soft exosuit does not use a leaf spring along the back of the body, but instead uses and extensional spring (possibly in conjunction with a clutch between the top of the spring and the shoulder harness to lock it in a fixed place or release it so it can move freely) or an actuator between the shoulder harness and differential strap, that can raise or lower the pulley or channel for the differential strap in the back of the body. Specifically, with a soft exosuit, the leg pads can ideally have plastic or another stiffening layer in them; the leg pads can have loops at the back so that a mechanism to adjust the differential strap can be positioned at the side or front of the wearer's leg; the differential strap can be adjusted by the series combination of a cam buckle and a strap buckle; and the tightness of the leg pad can be accomplished by a click buckle where half of it is retained by a strap, and half of it can be pulled by a second strap passing through a strap buckle.

The preceding mechanisms and devices can be used either individually or in combination. We also note that in all of the preceding devices, the leg pads could be secured to the wearer's knees or calves instead of to their thighs. This would not affect the functionality of the device.

Additionally, instead of having a leaf spring at the back of the exoskeleton, all of the above embodiments could use a differential strap that could elongate and store energy, such as a piece of elastic, natural gum rubber, a metal extension spring, or any of these energy storage devices in series with one or more pieces of webbing. For example, the differential strap could be comprised of a piece of inextensible webbing connected to the left leg pad, then a piece of elastic centered on the body that passed through the channel, then another piece of webbing connected to the right leg pad. The portions of the differential strap that were made of webbing could be used to adjust the length of the differential strap, in conjunction with buckles. The webbing could pass through loops at the back of the leg pads. Using a piece of elastic or other extensional spring at the back of the exoskeleton could potentially lead to a design that stays closer to the body than a leaf spring.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wearable device, comprising:
an upper body anchor configured for positioning on a torso of a user;
a first leg anchor configured for positioning on a first leg of the user;
a second leg anchor configured for positioning on a second leg of the user;
a connecting element between the first leg anchor and the second leg anchor; and
an energy storage device connected to the upper body anchor, that includes one or more pulleys or channels through which the connecting element passes, wherein the first leg anchor or the second leg anchor includes a stiffening layer.

2. The wearable device of claim 1, wherein:
the first leg anchor or the second leg anchor includes a loop at a back of either the first leg anchor or the second leg anchor retaining the connecting element, and
the connecting element terminates on the first leg anchor or the second leg anchor at a location further forward on the anchor than the loop at the back of either the first leg anchor or the second leg anchor

3. The wearable device of claim 1, wherein the energy storage device is a leaf spring.

4. The wearable device of claim 1, wherein the energy storage device is an extension spring.

5. The wearable device of claim 1, wherein the energy storage device is a battery used in conjunction with an actuator that is also mounted to the upper body anchor.

6. A back support exoskeleton or exosuit, comprising:
a first leg pad and a second leg pad respectively configured to secure around respective legs of a wearer; and
a differential strap configured to connect the first leg pad and left leg pad, wherein either the left leg pad or the right leg pad includes a stiffening layer.

7. The back support exoskeleton or exosuit of claim 6, wherein:
either the first leg pad or the second leg pad contains a loop disposed at a back surface of either the first leg pad or the left leg pad configured to retain the differential strap, and
the differential strap can be adjusted in length through a buckle that is disposed further forward on a respective leg pad than the loop at the back surface.

8. The back support exoskeleton or exosuit of claim 6, further comprising:
a V-shaped strap operably connected to a back portion of each leg pad, wherein the differential strap operably connects to a loop at a center of at least one V-shaped strap that connects the first leg pad and second leg pad.

9. The back support exoskeleton or exosuit of claim 6, further comprising:
a V-shaped strap operably connected to a back portion of each leg pad, wherein the differential strap operably connects to a center of at least one V-shaped strap that connects the first leg pad and second leg pad.

10. The back support exoskeleton or exosuit of claim 8, wherein at least one side of a V-shaped strap is reinforced with a stiffening layer.

11. The back support exoskeleton or exosuit of claim 9, wherein at least one side of a V-shaped strap is reinforced with a stiffening layer.

12. The back support exoskeleton or exosuit of claim 6, wherein tightness of respective leg pads are configured to be adjusted by a click buckle in series with a strap buckle.

13. The back support exoskeleton or exosuit of claim 12, wherein a first half of a click buckle is connected to the leg pad with an element on the pad that it can slide along, wherein:
the element along the pad it can slide along is secured to the leg pad,
the second half of the click buckle is connected to a piece of webbing that then passes through a strap buckle, and
the strap buckle is secured to the leg pad.

14. The back support exoskeleton or exosuit of claim 6, wherein the differential strap includes a cam buckle in series with a strap buckle configured to adjust tightness of the differential strap that is operable to connect the left leg pad and right leg pad.

15. The back support exoskeleton or exosuit of claim 6, further comprising:
an energy return mechanism, wherein the energy return mechanism comprises at least one spring structure having an upper spring and a lower spring, wherein each of the upper spring and lower spring comprises one or more beams, and wherein the upper spring and lower spring can be positioned relative to each other to increase or decrease overall length of the at least one spring structure.

16. The back support exoskeleton or exosuit of claim 6, further comprising:
an energy return mechanism, wherein the energy return mechanism comprises at least one stack of leaf springs, wherein the at least one stack of leaf springs include one or more beams, wherein the beams can be positioned relative to each other to adjust overall length of the spring.

17. The back support exoskeleton or exosuit of claim 16, wherein the one or more beams of two stacks of leaf springs are interleaved with each other.

18. The back support exoskeleton or exosuit of claim 6, wherein the lower spring rotates relative to the upper spring with a hinge, to enable the overall spring structure to become shorter in length.

19. The back support exoskeleton or exosuit of claim 6, further comprising rigid elements that are covered with fabric.

20. The back support exoskeleton or exosuit of claim 19, wherein the rigid elements are secured inside the fabric with a closure enabling them to be removed.

21. A wearable device, comprising:
an upper body anchor configured for positioning on a torso of a user;
a first leg anchor configured for positioning on a first leg of the user;
a second leg anchor configured for positioning on a second leg of the user;
a connecting element between the first leg anchor and the second leg anchor;
one or more pulleys or channels connected to the upper body anchor, through which the connecting element passes, wherein:
the first leg anchor or the second leg anchor includes a loop at a back surface of either the first leg anchor or the second leg anchor configured to retain the connecting element, and
the connecting element terminates on either the first leg anchor or the second leg anchor at a location further forward on the respective leg anchor than the loop at the back surface.

22. The wearable device of claim 21, where at least one portion of the connecting element is configured to store and release energy.

23. The wearable device of claim 21, where an actuator on at least one leg anchor is configured to extend or retract the connecting element so that the length between the leg anchors lengthens or shortens.

24. The wearable device of claim 21, further comprising:
a load distribution element connected to either the first leg anchor or the second leg anchor or both the first and second leg anchor, wherein:
each load distribution element is connected to a respective leg anchor at its ends, and
the connecting element that passes through the pulleys or channels is connected to the center of at least one load distribution element.

25. The wearable device of claim 24, wherein at least one side of at least one load distribution element is reinforced with a stiffening layer.

26. The wearable device of claim 21, further comprising:
one or more load distribution elements connected to the first leg anchor, the second leg anchor, or both of the first and second leg anchors, wherein:
each load distribution element of the one or more load distribution elements is connected to either the first or the second leg anchor at its ends,
at least one load distribution element includes a loop at its center; and
the connecting element that passes through the one or more pulleys or channels passes through the loop on a respective load distribution element before terminating on a respective leg anchor.

27. The wearable device of claim 26, wherein at least one side of at least one load distribution element is reinforced with a stiffening layer.

28. The wearable device of claim 21, wherein either the first leg anchor, the second leg anchor, or both the first and second leg anchor comprises a first end and a second end of the anchor, and wherein half a click buckle is operably connected to the first end and the other half of the click buckle in series with a strap buckle on the second end of the anchor.

29. The wearable device of claim 28, wherein an element is connected by its two ends to the second end of the anchor, wherein:
a first end of the click buckle is connected to this element,
the second end of the click buckle is connected to a piece of webbing that passes through the strap buckle, and
the strap buckle is connected to the second end of the anchor.

30. The wearable device of claim 21, wherein:
either the first leg anchor or the second leg anchor includes a cam buckle and strap buckle, and
the connecting element is configured to secure the first and the second leg anchor with the cam buckle and strap buckle.

31. The wearable device of claim 21, wherein the connecting element is a spring structure configured to connect to the upper body anchor, the first leg anchor, and the second leg anchor, wherein the spring structure comprises an upper spring and a lower spring, wherein each of the upper spring and lower spring are comprised of one or more beams, and wherein the upper spring and lower spring can be positioned relative to each other to increase or decrease overall length of the at least one spring structure.

32. The wearable device of claim 31, wherein the spring structure comprises: at least one stack of leaf springs, wherein the at least one stack of leaf springs include one or more beams, and wherein the one or more beams can be positioned relative to each other to increase or decrease the overall length of the spring structure.

33. The wearable device of claim 32, wherein the one or more beams of two stacks of leaf springs are interleaved with each other.
